(19) United States
(12) Patent Application Publication
(10) Pub. No.: US 2008/0318128 A1
(43) Pub. Date: Dec. 25, 2008

(54) Lithium alloy/sulfur batteries

(75) Inventors: Martin Simoneau, Ut-Bruno De Montarville (CA); Chariclea Scordilis-Kelley, Tucson, AZ (US); Tracy E. Kelley, Tucson, AZ (US)

Correspondence Address: WOLF GREENFIELD & SACKS, P.C., 600 ATLANTIC AVENUE, BOSTON, MA, 02210-2206, US

(73) Assignee: Sion Power Corporation, Tucson, AZ (US)

(21) Appl. No.: 11/821,576

(22) Filed: Jun. 22, 2007

(51) Int. Cl. H01M 4/40; H01M 4/42; H01M 4/46

(52) U.S. Cl. 429/229; 29/623.3; 429/231.6; 429/231.95

(57) ABSTRACT

Electrochemical cells including anode compositions that may enhance charge-discharge cycling efficiency and uniformity are presented. In some embodiments, alloys are incorporated into one or more components of an electrochemical cell, which may enhance the performance of the cell. For example, an alloy may be incorporated into an electroactive component of the cell (e.g., electrodes) and may advantageously increase the efficiency of cell performance. Some electrochemical cells (e.g., rechargeable batteries) may undergo a charge/discharge cycle involving deposition of metal (e.g., lithium metal) on the surface of the anode upon charging and reaction of the metal on the anode surface, wherein the metal diffuses from the anode surface, upon discharging. In some cases, the efficiency and uniformity of such processes may affect cell performance. The use of materials such as alloys in an electroactive component of the cell have been found to increase the efficiency of such processes and to increase the cycling lifetime of the cell. For example, the use of alloys may reduce the formation of dendrites on the anode surface and/or limit surface development.

### FIELD OF THE INVENTION

The present invention relates generally to electrochemical cells, and more specifically, to alloys for electrodes of electrochemical cells.

### BACKGROUND OF THE INVENTION

A typical electrochemical cell has a cathode and an anode which participate in an electrochemical reaction. In many electrochemical cells, including rechargeable electrochemical cells, the charge-discharge cycle involves a reversible cycle of plating and stripping of lithium metal on the surface of an electrode and diffusion of the lithium ions into the electrolyte. Metallic lithium batteries may often form a film of lithium on one or more electroactive components of the cell. The formation of such films can lead to a high lithium surface morphology which may electronically insulate, for example, the anode and may reduce the ionic exchange needed for the discharge of the lithium electrode. Also, lithium may form particulates such as dendrites on the surface of the anode, which may also reduce cycling efficiency. This problem can be substantially reduced in the case of rechargeable systems by using lithium alloys that have a high lithium diffusion rate and wherein deposition of metallic lithium during recharge is not a thermodynamically favored process. Instead, lithium is plated inside an intermetallic host crystalline structure, thus avoiding lithium morphology development and dendritic formation. However, while many lithium metal alloy anodes exist, many do not provide sufficient cycle lifetimes in addition to efficiency.

Accordingly, improved devices and methods are needed.

### SUMMARY OF THE INVENTION

Electrochemical cells, especially alloys for electrodes of electrochemical cells, are provided. The subject matter of the present invention involves, in some cases, interrelated products, alternative solutions to a particular problem, and/or a plurality of different uses of one or more systems and/or articles.

In one aspect of the invention, a series of methods of forming a rechargeable battery are provided. In one embodiment, a method includes providing an anode comprising a Li-Z alloy assembled onto a substrate, where Z is a metal or semiconductor and is present in an amount greater than 100 ppm but less than or equal to 10 wt % of the alloy, and wherein Z is substantially uniformly dispersed throughout a bulk portion of the anode prior to assembly of the Li-Z alloy onto the substrate. The method also includes providing a cathode comprising sulfur as an active cathode species, and combining the anode and cathode into a layered structure to form a rechargeable battery.

In another embodiment, a method of forming a rechargeable battery comprises co-depositing Li and Z onto a substrate to form an anode comprising a Li-Z alloy, where Z is a metal or semiconductor and is present in an amount greater than 100 ppm but less than or equal to 10 wt % of the alloy, and wherein Z is substantially uniformly dispersed throughout a bulk portion of the anode. The method also includes providing a cathode comprising sulfur as an active cathode species, and combining the anode and cathode into a layered structure to form a rechargeable battery.

In another aspect of the invention, a rechargeable battery having been discharged less than 10 times is provided. The rechargeable battery comprises a cathode comprising sulfur as an active cathode species, and an anode comprising a Li-Z metal alloy, where Z is a metal or semiconductor and is present in an amount greater than 100 ppm but less than or equal to 10 wt % of the alloy, wherein Z is substantially uniformly dispersed throughout a bulk portion of the anode prior to 10^{th} discharge. The rechargeable battery has a discharge capacity of at least 1800 mAh at the end of the 45^{th} cycle, the discharge capacity being at least 10% greater than that of a second rechargeable battery of essentially identical composition and dimension but comprising a Li anode without Z.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a schematic diagram of a cross-section of an anode according to one embodiment of the invention;

FIG. 2 shows a graph of discharge capacity as a function of cell cycle for rechargeable batteries including various anode compositions according to another embodiment of the invention;

FIG. 3 shows another graph of discharge capacity as a function of cell cycle for rechargeable batteries including various anode compositions according to another embodiment of the invention; and

FIG. 4 shows another graph of discharge capacity as a function of cell cycle for rechargeable batteries including various anode compositions according to another embodiment of the invention.

### DETAILED DESCRIPTION

The present invention relates generally to electrochemical cells, and more specifically, to anodes for electrochemical cells. In particular, anode compositions that may enhance charge-discharge cycling efficiency and uniformity are presented.

Specifically, the present invention relates to the incorporation of alloys into one or more components of an electrochemical cell, which may enhance the performance of the cell. For example, an alloy may be incorporated into an electroactive component of the cell (e.g., electrodes) and may advantageously increase the efficiency of cell performance. Some electrochemical cells (e.g., rechargeable batteries) may undergo a charge/discharge cycle involving deposition of metal (e.g., lithium metal) on the surface of the anode upon charging and reaction of the metal on the anode surface, wherein the metal diffuses from the anode surface, upon discharging. In some cases, the efficiency and uniformity of such processes may affect cell performance. The use of materials such as alloys in an electroactive component of the cell have been found, in accordance with the invention, to increase the efficiency of such processes and to increase the cycling lifetime of the cell. For example, the use of alloys may reduce the formation of dendrites on the anode surface and/or limit surface development.

The following documents are incorporated herein by reference in their entirety: U.S. Pat. No. 6,797,428 filed Nov. 11, 2000 by Skotheim et al., entitled, “Lithium Anodes for Electrochemical Cells”; U.S. Pat. No. 6,733,924 filed Nov. 11, 2000 by Skotheim et al., entitled, “Lithium Anodes for Electrochemical Cells”; U.S. Pat. No. 6,936,381 filed Aug. 6, 2004 by Skotheim et al., entitled, “Lithium Anodes for Electrochemical Cells”; and U.S. Patent Publication No. 2006/0222954 filed Jun. 13, 2006 by Skotheim et al., entitled, “Lithium Anodes for Electrochemical Cells”.

One aspect of the invention is the discovery that lithium metal alloys having the formula, Li-Z, function well in an electrochemical cell when low amounts of Z are present, i.e., the cell may efficiently undergo charge-discharge cycling and/or may reduce or prevent formation of lithium dendrites or other compositions that may form on the surface of an electrode. Those of ordinary skill in the art would have expected that lithium metal alloys (e.g., Li-Z) having a higher amounts of Z would more efficiently allow for the reaction of lithium metal to form lithium ions and diffuse away from the electrode surface. It would have been unexpected that improved cycling properties would be found with lithium metal alloys having small amount of the alloying element (e.g., “Z”) in accordance with the invention. However, this has surprisingly been found to be the case.

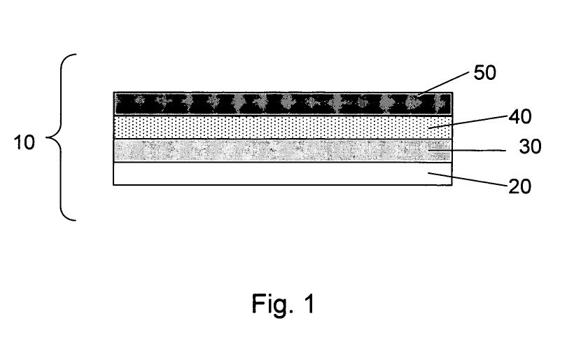

Although a Li-Z electrode of the invention can find use in a wide variety of electrochemical devices, an example of one such device is provided in FIG. 1 for illustrative purposes only. In FIG. 1, a general embodiment of an electrochemical cell can include a cathode, an anode, and an electrolyte layer in contact with both electrodes. The components may be assembled such that the electrolyte is placed between the cathode and anode in a stacked or layered configuration. As shown in the embodiment illustrated in FIG. 1, an electrochemical cell 10 includes a cathode 30 that can be formed on a substantially planar surface of substrate 20. A porous separator material 40 can be formed adjacent to the cathode 30 and can be deposited onto the cathode. An anode layer 50 can be formed adjacent porous separator material 40 and may be in electrical communication with the cathode. The anode may be deposited onto or layered against the electrolyte layer. Of course, the orientation of the components can be varied and it should be understood that there are other embodiments in which the orientation of the layers is varied such that, for example, the anode layer or the electrolyte layer is deposited onto or laminated with a substrate. Optionally, additional layers (not shown), such as a multi-layer structure that protects the electroactive material from the electrolyte, may be present adjacent an electroactive material (e.g., between cathode 30 and porous separator material 40 and/or between anode 50 and porous separator material 40), as described in more detail in U.S. patent application Ser. No. 11/400,781, filed Apr. 6, 2006, entitled, “Rechargeable Lithium/Water, Lithium/Air Batteries” to Affinito et al., which is incorporated herein by reference in its entirety. Additionally, non-planar arrangements, arrangements with proportions of materials different than those shown, and other alternative arrangements are useful in connection with the present invention. A typical electrochemical cell also would include, of course, current collectors, external circuitry, housing structure, and the like. Those of ordinary skill in the art are well aware of the many arrangements that can be utilized with the general schematic arrangement as shown in FIG. 1 and described herein.

As mentioned above, in some embodiments, the present invention relates to electrochemical devices comprising at least one electrode comprising an alloy, wherein the alloy comprises lithium and at least one additive, i.e., Z, in the alloy, Li-Z. In most embodiments, Li-Z forms a part of or all of an anode in an electrochemical cell. However, it can form a portion of a cathode as well. It is to be understood that, while the invention is described herein, primarily in the context of an anode, wherever “anode” is used, the invention can be applied to any suitable electrode.

The additive, Z, may be any material capable of forming an alloy with lithium (or other suitable electroactive metal). The term “alloy” is given its ordinary meaning in the art, and refers to a combination (e.g., solid, solid solution) of two or more elements, wherein at least one element is a metal, and wherein the resulting material has metallic properties.

In one specific set of embodiments, Z is a metal. In other embodiments, Z is a different material. In some cases, Z may be a semiconductor. Materials suitable for use as Z include, for example, a Group 1-17 element, a Group 2-14 element, or a Group 2, 10, 11, 12, 13, 14, 15 element. Suitable elements from Group 2 of the Periodic Table may include beryllium, magnesium, calcium, strontium, barium, and radium. Suitable elements from Group 10 may include, for example, nickel, palladium, or platinum. Suitable elements from Group 11 may include, for example, copper, silver, or gold. Suitable elements from Group 12 may include, for example, zinc, cadmium, or mercury. Elements from Group 13 that may be used in the present invention may include, for example, boron, aluminum, gallium, indium, or thallium. Elements from Group 14 that may be used in the present invention may include, for example, carbon, silicon, germanium, tin, or lead. Elements from Group 15 that may be used in the present invention may include, for example, nitrogen, phosphorus, or bismuth. In some cases, Z is Al, Mg, Zn, or Si. In some cases, Z is Al. In other cases, Z is Mg.

Where Z is a metal, it is to be understood that one or more metals can be used. Similarly, where Z is a semiconductor, one or more semiconducting materials can be used. Additionally, metals and semiconductors can be mixed. That is, Z can be a single metal, a single semiconductor, or one or more metals or one or more semiconductors mixed. Non-limiting examples of suitable metals are listed above, and suitable components of semiconductors are listed above. Those of ordinary skill in the art are well aware of semiconductors that can be formed from one or more of the elements listed above, or other elements.

In certain cases, Z is a nonmetal. For example, Z may be N, O, or C. In some instances, N, O, C, or other nonmetals that may form an alloy with lithium are in the form of a gas (e.g., N₂, O₂, and CO₂) prior to forming an alloy with lithium. In embodiments where Z is a nonmetal, the Li-Z metal alloy may have a primary phase consisting essentially of Li and a secondary phase consisting essentially of LiₓZ_{y} and Z, wherein the secondary phase is substantially non-electrically conducting.

Those of ordinary skill in the art can easily select, from materials described above or materials known in the field, suitable metals, semiconductors, and/or nonmetals, and can easily screen materials for suitable use in connection with the invention.

In the following discussion, reference will be made to material (e.g., “Z”) “substantially uniformly dispersed throughout a bulk portion of” a material, such as an anode or another electrode. “Substantially uniformly dispersed,” in this context, means that, upon viewing a cross-sectional portion of any such material, where the cross-section may comprise the average makeup of a number of random cross-sectional positions of the material, investigation of the material at a size specificity on the order of grains, or atoms, reveals essentially uniform dispersement of Z in the bulk material. For example, a photomicrograph, scanning electron micrograph, or other similar microscale or nanoscale investigative process will reveal essentially uniform distribution. “A bulk portion” of a material includes at least 50% of a cross-sectional dimension of the material. In certain embodiments, a bulk portion may comprise at least 60%, 70%, 80%, 90%, or 95% of a cross-sectional dimension of the material. Those of ordinary skill in the art, with this description, will understand clearly the meaning of these terms.

Those of ordinary skill in the art can also determine the degree of dispersion of a first material (e.g., Z) in a second material (e.g., lithium) by diffusion calculations based on parameters such as the type of materials, concentration/amounts and thicknesses of the materials, temperature, the time allowed for diffusion, etc. Generally, a very thin layer of a first material on a second material will facilitate faster dispersion of the first material into the second material (e.g., to form a uniformly dispersed layer of the two materials), compared to a thicker layer of the first material on the second material. The degree of dispersion also depends on the method of fabricating the materials. For instance, physical mixing and/or co-deposition of a first and a second material may form substantially uniformly dispersed materials prior to charge or discharge of the cell, whereas in certain embodiments involving layers of materials, the materials are not uniformly dispersed until after a certain charge/discharge cycle. The latter may occur because charge and/or discharge of the cell can also facilitate dispersion. For instance, a first material is more likely to be uniformly dispersed within a second material after 20^{th} discharge than after 1^{st} discharge of the cell.

As mentioned, Z may be substantially uniformly dispersed throughout a bulk portion of an electrode, e.g., prior to assembly of the alloy onto a substrate or prior to X^{th} discharge, as described herein. In other embodiments, however, Z is not substantially uniformly dispersed throughout a bulk portion of an electrode. For instance, Z may form a gradient within the alloy or Z may be in the form of a layer on top of a bulk portion of the electrode.

As also described herein, the makeup of an electrode (e.g., substantially uniform dispersion of Z within a bulk portion) and/or electrode performance (e.g., in the context of discharged capacity) are described in the context of an electrode having been discharged less than a certain number of times, e.g., “prior to X^{th} discharge” or “having been discharged less than X times”. Those of ordinary skill in the art are aware that when an electrochemical device such as a rechargeable battery (or primary battery or other electrochemical device useful in connection with the invention) is first made, it may undergo a first charge, first discharge, second charge, second discharge, etc. In some cases, the battery has been subjected to one or more charge/discharge cycles at prior to being offered for commercial sale. However, a rechargeable battery offered for first commercial sale typically has been charged and discharged no more than a limited number of times. Those of ordinary skill in the art will understand several factors relating to this parameter. First, it will be understood that, for most batteries, performance of the battery may decrease and material organization within the battery may change, upon successive charge/discharge cycles. Second, it will be understood why a recitation specifically relating to the performance of the battery or material makeup early in the life of the battery (e.g., prior to X^{th} discharge) is important. Also, while one cannot always tell, by investigating a particular battery, how many charge/discharge cycles the battery has undergone, one often can be fully aware that when a battery is first purchased upon first retail sale, it will not have undergone more than a certain number of charge/discharge cycles.

Accordingly, in some embodiments, Z is substantially uniformly dispersed throughout a bulk portion of the anode prior to 10^{th} discharge. In some cases, Z is substantially uniformly dispersed throughout a bulk portion of the anode prior to 5^{th} discharge, or, in some cases, prior to 3^{rd} discharge, or in other cases, prior to 1^{st} discharge. In yet other cases, Z is substantially uniformly dispersed throughout a bulk portion of the anode prior to 15^{th}, 20^{th}, or 25^{th} discharge.

It is also to be understood that “prior to X^{th} discharge”, or “having been discharged less than X times” or the like, means at a time or times prior to a point where a rechargeable electrochemical device has been charged and discharged no more than X times, where charge means essentially full charge, and discharge means, on average of all discharges, at least 75% discharge.

In some cases, Z may be a metal or semiconductor that is present, in an electrode, in an amount greater than 25 ppm, 50 ppm, 100 ppm, 200 ppm, 300 ppm, 400 ppm or 500 ppm, but less than or equal to 1 wt %, 2 wt %, 5 wt %, 10 wt %, 12 wt %, 15 wt %, or 20 wt % of the alloy or electrode. As used herein, “wt %” means percent by total weight of the alloy or electrode itself, absent current collector, electrolyte and other materials.

As noted, batteries utilizing electrodes of the invention exhibit surprising performance characteristics. In one embodiment, a rechargeable battery of the invention has a discharge capacity of at least 1000, 1200, 1600, or 1800 mAh at the end of the battery's 15^{th}, 25^{th}, 30^{th}, 40^{th}, 45^{th}, 50^{th}, or 60^{th} cycle. The discharge capacity may be at least 2%, 5%, 7%, 10%, or 15% greater than that of a second rechargeable battery of essentially identical composition and dimension but comprising a Li anode without Z. In one set of embodiments, a rechargeable battery of the invention, including one of those described above or otherwise, is established such that there is a potential difference between its anode and that of the “second rechargeable battery” discussed above that is less than 5, 10, or 15 mV.

Accordingly, one aspect of the invention includes a rechargeable battery having a certain configuration and performance characteristics. For instance, in one embodiment, a rechargeable battery having been discharged less than 10 times, or in other embodiments, less than 8, 6, 4, 2, or 1 time, comprises a cathode comprising sulfur as an active cathode species and an anode comprising a Li-Z alloy. Z is a metal or semiconductor and is present in an amount greater than 100 ppm but less than or equal to, e.g., 15 wt %, 10 wt %, 7 wt %, 5 wt %, or 3 wt % of the alloy. In such an embodiment, Z may be substantially uniformly dispersed throughout a bulk portion of the anode prior to 10^{th} discharge (or, in other embodiments, prior to 8^{th}, 6^{th}, 4^{th}, 2^{nd}, or 1^{st} discharge). The rechargeable battery may have a discharge capacity of at least 1800 mAh at the end of the 45^{th} cycle, the discharge capacity being at least 10% greater than that of a second rechargeable battery of essentially identical composition and dimension but comprising a Li anode without Z.

Another measure of some of the surprising performance characteristics of the invention includes energy density (which can be expressed as Watt Hours Per Kilogram (Wh/kg) or energy per size, as expressed as Watt Hours Per Liter (Wh/l)). Various energy density and energy per size characteristics exhibited by batteries of the present invention prior to X^{th} discharge, where X is any of the numbers described herein, include, for example, at least 200, at least 250, at least 300, at least 350, or at least 400 Wh/kg.

In one set of embodiments, the Li-Z alloy has a primary phase consisting essentially of Li and a secondary phase consisting essentially of LiₓZ_{y}, the secondary phase being substantially non-electrically conducting. Where a multiple phase arrangement such as that described immediately above exists, the phase is typically usually distinguishable by SEM or other suitable technique and at least one of the phases has an average cross-sectional dimension in the range of, for example, 0.1-100 microns, 0.5-50 microns, or, in some cases, 0.5-10 microns. Especially in connection with these embodiments, Z, in addition to being in one or more of the materials described above, can be nitrogen, oxygen, or carbon.

Anodes described herein, such as Li-Z alloys and including layers formed adjacent the anode (e.g., protective multi-layers), may be formed by any suitable method. Such methods may include, for example, physical deposition methods, chemical vapor deposition methods, plasma enhanced chemical vapor deposition techniques, thermal evaporation (e.g., resistive, inductive, radiation, and electron beam heating), sputtering (e.g., diode, DC magnetron, RF, RF magnetron, pulsed, dual magnetron, AC, FM, and reactive sputtering), jet vapor deposition, laser ablation, extrusion, electroplating, ion plating, and cathodic arc. In some instances, Li vapor and a vapor of Z (e.g., a metal, semiconductor, or gas) are co-deposited (simultaneously) onto a substrate, e.g., using methods such as those mentioned above, to form a Li-Z alloy anode. Deposition can be carried out in a vacuum or inert atmosphere.

In certain embodiments, a method of forming a rechargeable battery includes co-depositing Li and Z onto a substrate to form an anode comprising a Li-Z alloy, where Z is a metal or semiconductor and is present in an amount greater than, e.g., 50 ppm, 70 ppm, or 100 ppm, but less than or equal to, e.g., 15 wt %, 12 wt %, 10 wt %, 7 wt %, 5 wt %, or 3 wt % of the alloy, and wherein Z is substantially uniformly dispersed throughout a bulk portion of the anode. The method may also include providing a cathode comprising sulfur as an active cathode species and combining the anode and cathode into a layered structure to form a rechargeable battery. Any suitable electrolyte may be used.

In other embodiments, a method of forming a rechargeable battery includes providing an anode comprising a Li-Z alloy assembled onto a substrate (e.g., a conductive support), where Z is a metal or semiconductor and is present in an amount greater than, e.g., 50 ppm, 70 ppm, or 100 ppm, but less than or equal to, e.g., 10 wt %, 7 wt %, 5 wt %, or 3 wt % of the alloy, and wherein Z is substantially uniformly dispersed throughout a bulk portion of the anode prior to assembly of the Li-Z alloy onto the substrate. The method may further include providing a cathode comprising sulfur as an active cathode species and combining the anode and cathode into a layered structure to form a rechargeable battery.

In the above-mentioned method, providing the anode may include, for example, providing the Li-Z alloy wherein Z is substantially uniformly dispersed throughout a bulk portion of the anode, and then assembling the Li-Z alloy onto the substrate. In one embodiment, the Li-Z alloy is assembled onto the substrate by laminating a Li-Z alloy foil and the substrate. These components can be laminated together by a lamination process as known in the art to form an anode layer. Optionally, additional layers (e.g., multi-layered protective layers) may be deposited onto the alloy layer.

In some cases, Li-Z alloys are formed using ingots, e.g., via co-precipitation, co-deposition, and/or physical mixing techniques. The alloys may be cast as a sheet or thin film. Li-Z alloys can also be formed by preparing a layered Li-Z structure (e.g., a Li-Z laminate) and then exposing the structure to an non-aqueous solution (e.g., an organic solvent) containing a lithium salt. While not wishing to be bound by any theory, it is believed that when lithium is in contact with Z (e.g., Al) a non-aqueous solution containing lithium ions, corrosion of lithium occurs leading to the formation of a lithium-Z (e.g., Li—Al). In other cases, Li-Z alloys can be made by electrolysis of Z in Li-containing molten salts. These and other techniques may be used to form, for example, Li-Z anodes where Z is substantially uniformly dispersed throughout a bulk portion of the anode.

Although not wishing to be bound by any theory, the inventors of the present invention offer the following discussion of the relationship between the presence of Z in a Li-Z anode arrangement and performance characteristics observed. In typical lithium anode batteries, after a few charge/discharge cycles of a battery, adverse morphological changes of the anode can occur. Lithium alloys of the invention can exhibit more uniform plating that may delay and/or prevent formation of dendrites and other adverse structures. During charge and discharge, lithium is removed from and then replated onto (forms a film on) the anode. However, it has been realized that such films can electronically insulate an important fraction of the lithium when the latter is present in particulate form. One then observes an important decrease of the utilization of the negative electrode, which decrease must then be compensated by an excess capacity of the negative electrode. Use of devices and methods as described herein may reduce or prevent the formation of dendrites of lithium and the electrical insulation of lithium, which can improve the cycle life of the batteries.

Suitable electroactive materials for use as cathode active materials in the cathode of the electrochemical cells of the invention include, but are not limited to, electroactive transition metal chalcogenides, electroactive conductive polymers, electroactive sulfur-containing materials, and combinations thereof. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a cathode includes one or more of the following materials: manganese dioxide, carbon monoflouride, iodine, silver chromate, silver oxide and vanadium pentoxide, vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Preferred conductive polymers include polypyrroles, polyanilines, and polyacetylenes.

In some embodiments, electroactive materials for use as cathode active materials in electrochemical cells described herein include electroactive sulfur-containing materials. “Electroactive sulfur-containing materials,” as used herein, relates to cathode active materials which comprise the element sulfur in any form, wherein the electrochemical activity involves the oxidation or reduction of sulfur atoms or moieties. The nature of the electroactive sulfur-containing materials useful in the practice of this invention may vary widely, as known in the art. For example, in one embodiment, the electroactive sulfur-containing material comprises elemental sulfur. In another embodiment, the electroactive sulfur-containing material comprises a mixture of elemental sulfur and a sulfur-containing polymer. Thus, suitable electroactive sulfur-containing materials may include, but are not limited to, elemental sulfur and organic materials comprising sulfur atoms and carbon atoms, which may or may not be polymeric. Suitable organic materials include those further comprising heteroatoms, conductive polymer segments, composites, and conductive polymers.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al. of the common assignee, and PCT Publication No. WO 99/33130. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al.

In one embodiment, an electroactive sulfur-containing material of a cathode active layer comprises greater than 50% by weight of sulfur. In another embodiment, the electroactive sulfur-containing material comprises greater than 75% by weight of sulfur. In yet another embodiment, the electroactive sulfur-containing material comprises greater than 90% by weight of sulfur.

The cathode active layers of the present invention may comprise from about 20 to 100% by weight of electroactive cathode materials (e.g., as measured after an appropriate amount of solvent has been removed from the cathode active layer and/or after the layer has been appropriately cured). In one embodiment, the amount of electroactive sulfur-containing material in the cathode active layer is in the range of 5-30% by weight of the cathode active layer. In another embodiment, the amount of electroactive sulfur-containing material in the cathode active layer is in the range of 20% to 90% by weight of the cathode active layer.

Non-limiting examples of suitable liquid media (e.g., solvents) for the preparation of cathodes (as well as other components of cells described herein) include aqueous liquids, non-aqueous liquids, and mixtures thereof. In some embodiments, liquids such as, for example, water, methanol, ethanol, isopropanol, propanol, butanol, tetrahydrofuran, dimethoxyethane, acetone, toluene, xylene, acetonitrile, cyclohexane, and mixtures thereof can be used. Of course, other suitable solvents can also be used as needed.

Positive electrode layers may be prepared by methods known in the art. For example, one suitable method comprises the steps of: (a) dispersing or suspending in a liquid medium the electroactive sulfur-containing material, as described herein; (b) optionally adding to the mixture of step (a) a conductive filler and/or binder; (c) mixing the composition resulting from step (b) to disperse the electroactive sulfur-containing material; (d) casting the composition resulting from step (c) onto a suitable substrate; and (e) removing some or all of the liquid from the composition resulting from step (d) to provide the cathode active layer.

Positive and/or negative electrodes may optionally include one or more layers (e.g., multi-layers) that interact favorably with a suitable electrolyte, such as those described in an U.S. Provisional Application filed Dec. 4, 2006 and entitled “Separation of Electrolytes”, by Mikhaylik et al., which is incorporated herein by reference in its entirety.

The electrolytes used in electrochemical or battery cells can function as a medium for the storage and transport of ions, and in the special case of solid electrolytes and gel electrolytes, these materials may additionally function as a separator between the anode and the cathode. Any liquid, solid, or gel material capable of storing and transporting ions may be used, so long as the material is electrochemically and chemically unreactive with respect to the anode and the cathode, and the material facilitates the transport of ions (e.g., lithium ions) between the anode and the cathode. The electrolyte is electronically non-conductive to prevent short circuiting between the anode and the cathode.

The electrolyte can comprise one or more ionic electrolyte salts to provide ionic conductivity and one or more liquid electrolyte solvents, gel polymer materials, or polymer materials. Suitable non-aqueous electrolytes may include organic electrolytes comprising one or more materials selected from the group consisting of liquid electrolytes, gel polymer electrolytes, and solid polymer electrolytes. Examples of non-aqueous electrolytes for lithium batteries are described by Dominey in Lithium Batteries, New Materials, Developments and Perspectives, Chapter 4, pp. 137-165, Elsevier, Amsterdam (1994). Examples of gel polymer electrolytes and solid polymer electrolytes are described by Alamgir et al. in Lithium Batteries, New Materials, Developments and Perspectives, Chapter 3, pp. 93-136, Elsevier, Amsterdam (1994). Heterogeneous electrolyte compositions that can be used in batteries described herein are described in an U.S. Provisional Application filed Dec. 4, 2006 and entitled “Separation of Electrolytes”, by Mikhaylik et al.

Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, cyclic ethers, glymes, polyethers, phosphate esters, siloxanes, dioxolanes, N-alkylpyrrolidones, substituted forms of the foregoing, and blends thereof. Fluorinated derivatives of the foregoing are also useful as liquid electrolyte solvents.

In some cases, aqueous solvents can be used as electrolytes for lithium cells. Aqueous solvents can include water, which can contain other components such as ionic salts. As noted above, in some embodiments, the electrolyte can include species such as lithium hydroxide, or other species rendering the electrolyte basic, so as to reduce the concentration of hydrogen ions in the electrolyte.

Liquid electrolyte solvents can also be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, derivatives of the foregoing, copolymers of the foregoing, crosslinked and network structures of the foregoing, and blends of the foregoing, and optionally, one or more plasticizers. In some embodiments, a gel polymer electrolyte comprises between 10-20%, 20-40%, between 60-70%, between 70-80%, between 80-90%, or between 90-95% of a heterogeneous electrolyte by volume.

In some embodiments, one or more solid polymers can be used to form an electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In addition to electrolyte solvents, gelling agents, and polymers as known in the art for forming electrolytes, the electrolyte may further comprise one or more ionic electrolyte salts, also as known in the art, to increase the ionic conductivity.

Examples of ionic electrolyte salts for use in the electrolytes of the present invention include, but are not limited to, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂. Other electrolyte salts that may be useful include lithium polysulfides (Li₂Sₓ), and lithium salts of organic ionic polysulfides (LiSₓR)ₙ, where x is an integer from 1 to 20, n is an integer from 1 to 3, and R is an organic group, and those disclosed in U.S. Pat. No. 5,538,812 to Lee et al.

In some embodiments, electrochemical cells may further comprise a separator interposed between the cathode and anode. The separator may be a solid non-conductive or insulative material which separates or insulates the anode and the cathode from each other preventing short circuiting, and which permits the transport of ions between the anode and the cathode.

The pores of the separator may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A variety of separator materials are known in the art. Examples of suitable solid porous separator materials include, but are not limited to, polyolefins, such as, for example, polyethylenes and polypropylenes, glass fiber filter papers, and ceramic materials. Further examples of separators and separator materials suitable for use in this invention are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545 by Carlson et al. of the common assignee. Solid electrolytes and gel electrolytes may also function as a separator in addition to their electrolyte function.

In some embodiments, an electrode is associated with a conductive support. For instance, an anode or cathode may be deposited on or laminated with a conductive support.

The conductive support can function as a current collector useful in efficiently collecting the electrical current generated throughout the electrode and in providing an efficient surface for attachment of the electrical contacts leading to the external circuit. A wide range of conductive supports are known in the art. Suitable conductive supports include, but are not limited to, those including metal foils (e.g., aluminum foil), polymer films, metallized polymer films (e.g., aluminized plastic films, such as aluminized polyester film), electrically conductive polymer films, polymer films having an electrically conductive coating, electrically conductive polymer films having an electrically conductive metal coating, polymer films having conductive particles dispersed therein, and combinations thereof. In some embodiments, the conductive support may comprise a conductive metal such as aluminum, copper, and nickel. Other conductive supports may include, for example, expanded metals, metal mesh, metal grids, expanded metal grids, metal wool, woven carbon fabric, woven carbon mesh, non-woven carbon mesh, and carbon felt.

The figures that accompany this disclosure are schematic only, and illustrate a substantially flat battery arrangement. It is to be understood that any electrochemical cell arrangement can be constructed, employing the principles of the present invention, in any configuration. For example, additional configurations are described in U.S. patent application Ser. No. 11/400,025, filed Apr. 6, 2006, entitled, “Electrode Protection in both Aqueous and Non-Aqueous Electrochemical Cells, including Rechargeable Lithium Batteries,” to Affinito et al., which is incorporated herein by reference in its entirety.

### EXAMPLES

The following examples are intended to illustrate certain embodiments of the present invention, but are not to be construed as limiting and do not exemplify the full scope of the invention. The following materials were used as received in the Examples below: elemental sulfur (available from Aldrich Chemical Company, Milwaukee, Wis.); a conductive carbon pigment, PRINTEX® XE-2 (available from Degussa Corporation, Akron, Ohio); a conductive pigment, Ketjenblack® (available from Akzo Nobel, the Netherlands); polyethylene powder (grade T1000, available from Baker Hughes, Bamsdall, Okla.); lithium bis(trifluoromethane sulfonyl) imide (available from 3M Corporation, St. Paul, Minn.); lithium nitrate (available from Aldrich Chemical Company, Milwaukee, Wis.); guanidine nitrate (also available from Aldrich Chemical Company, Milwaukee, Wis.); LectroMax 120, a Lithium-Aluminum alloy (0.2 wt. % Al) foil 2.4 mil in thickness (available from FMC Corp., Charlotte, N.C. as a 0.1-4.0 wt. % Aluminum alloy); a lithium-aluminum alloy (obtained from Kisco, Kishimoto Sangyo Co., Japan); and 9-micron SETELA® (a polyolefin separator available from Tonen Chemical Corporation, Tokyo, Japan, and also available from Mobil Chemical Company, Films Division, Pittsford, N.Y.); >99.9% Li metal (2.1 mil thick foil) (available from Chemetall-Foote Corp., Kings Mountain, N.C.).

### Example 1

This example describes a protocol for preparing an electrochemical cell comprising a Li—Al alloy anode and a sulfur cathode including a porous, polyolefin separator, according to one embodiment of the invention. The electrochemical cell was fabricated to contain a Li—Al alloy anode, a sulfur cathode, a porous separator, and an electrolyte.

To prepare the cathode, a mixture of 73 wt % of elemental sulfur, 16 wt % of a first conductive carbon pigment, PRINTEX® XE-2, 6 wt % of a second conductive pigment, Ketjenblack®, and 5 wt % of polyethylene powder (grade T1000) dispersed in isopropanol was coated onto a 12 micron thick conductive carbon-coated aluminum/PET substrate. After drying the coated cathode active layer, the thickness of the film was measured to be about 40 microns. To prepare the electrolyte, a mixture containing 15.7 wt % of lithium bis (trifluoromethane sulfonyl) imide, 3.8 wt % lithium nitrate, 1 wt % guanidine nitrate, and 0.4 parts pyridine nitrate (synthesized from pyridine and nitric acid) were combined with 1,3-dioxolane and dimethoxyethane (1:1 weight ratio mixture), with water content of less than 50 ppm. The anode used was LectroMax 120, a Lithium-Aluminum alloy (0.2 wt. % Al) foil 2.4 mil in thickness (available from FMC Corp., Charlotte, N.C. as a 0.1-4.0 wt. % Aluminum alloy). The porous separator used was 9 micron SETELA®.

The above components were combined into a layered structure of cathode/separator/anode, which was wound and compressed, with the liquid electrolyte filling the void areas of the separator and cathode to form prismatic cells with an electrode area of about 900 cm². After sealing, the cells were stored for 48 hours and any gas which had formed in the cells was vented. The cells were then re-sealed.

Discharge-charge cycling of the cells was performed at 500 mA/315 mA, respectively, with discharge cutoff at a voltage of 1.7V and charge cutoff of 2.5V. As a control experiment, cells containing a lithium metal anode were prepared. The general procedure described above was followed, except that the anodes used were >99.9% Li metal (2.1 mil thick foil).

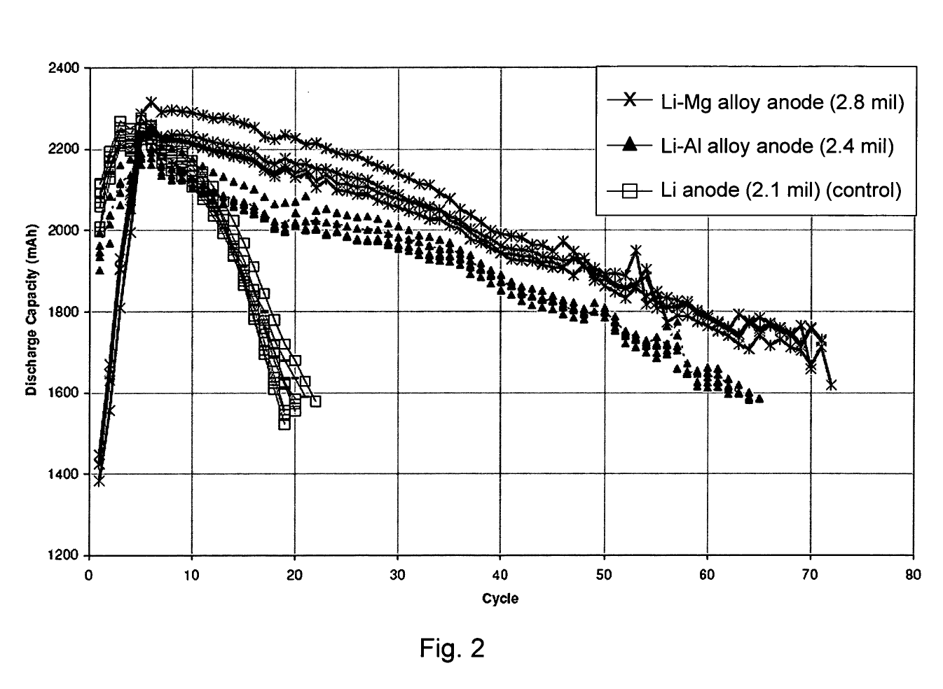

As shown in FIG. 2, upon cycling, the cells containing the Li—Al anodes performed 47 cycles to 1800 mAh (about 80% of the early cycle capacity). By contrast, the cells containing the lithium metal anodes (control) performed on 18 cycles to 1800 mAh (approximately 80% of the early cycle capacity). “Early cycle capacity” is determined by the average peak capacity typically occurring near the 5^{th} cycle.

### Example 2

A layered structure was fabricated to contain a Li—Mg alloy anode, a cathode, a porous separator, and an electrolyte. The cell was assembled according to the general procedure described in Example 1, with the exception that the anode used was a Li—Mg alloy having 10 wt % Mg (2.8 mil thick). As a control experiment, cells containing a lithium metal anode were also prepared. The general procedure described above was followed, except that the anodes used were >99.9% Li metal (3.0 mil thick foil).

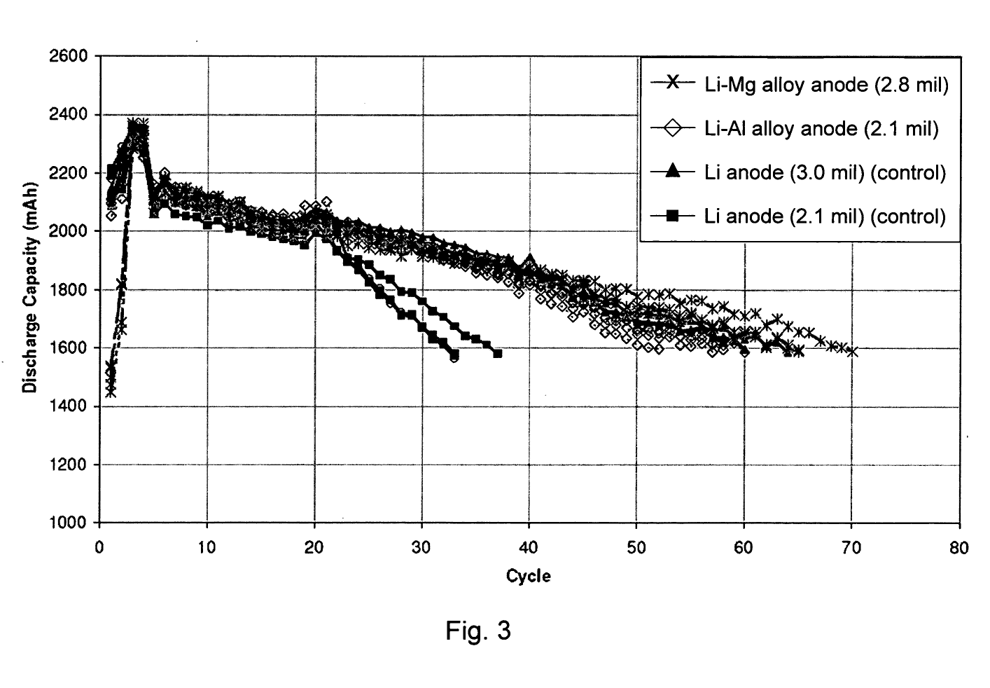

As shown in FIG. 3, upon cycling, the cells containing the Li—Mg alloy anodes performed 70 cycles to 1600 mAh (about 74% of the 6^{th} cycle capacity). By contrast, the cells containing the lithium metal anodes (control) performed on 64 cycles to 1600 mAh (approximately 75% of the 6^{th} cycle capacity).

### Example 3

Prismatic cells was fabricated to contain a Li—Al alloy anode, a cathode, a porous separator, and an electrolyte. The cell was assembled according to the general procedure described in Example 1, with the exception that the anode used was a Li—Al alloy having 0.2 wt % Al (1.93 mil thick), and the cells were activated with 7.6 g of a DOL/DME based electrolyte containing 40 wt % DOL, 40 wt % DME, 16.5 wt % LiTFSI, 2.1 wt % LiNO₃, 1% guanidine nitrate, and 0.4% pyridine nitrate. As a control experiment, cells containing a lithium metal anode were also prepared. The general procedure described above was followed, except that the anodes used were >99.9% Li metal (2.1 mil thick).

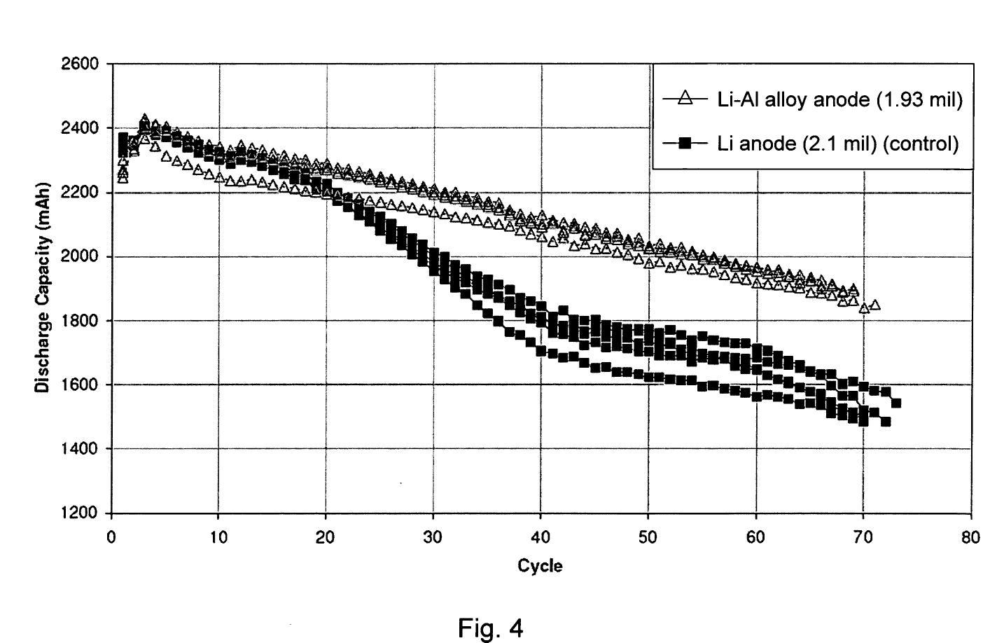

As shown in FIG. 4, upon cycling, the cells containing the Li—Al alloy anodes performed 70 cycles to 1800 mAh (about 80% of the early cycle capacity). By contrast, the cells containing the lithium metal anodes (control) performed on 40 cycles to 1800 mAh (approximately 80% of the early cycle capacity).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. A method of forming a rechargeable battery, comprising:
providing an anode comprising a Li-Z alloy assembled onto a substrate, where Z is a metal or semiconductor and is present in an amount greater than 100 ppm but less than or equal to 10 wt % of the alloy, and wherein Z is substantially uniformly dispersed throughout a bulk portion of the anode prior to assembly of the Li-Z alloy onto the substrate;
providing a cathode comprising sulfur as an active cathode species; and
combining the anode and cathode into a layered structure to form a rechargeable battery.

2. A method as in claim 1, wherein providing the anode comprises:
providing the Li-Z alloy wherein Z is substantially uniformly dispersed throughout a bulk portion of the anode, and then assembling the Li-Z alloy onto the substrate.

3. A method as in claim 1, wherein the Li-Z alloy is assembled onto the substrate by laminating a Li-Z alloy foil and the substrate.

4. A method as in claim 1, wherein the substrate is a conductive support.

5. A rechargeable battery as in claim 1, wherein Z is a metal.

6. A rechargeable battery as in claim 1, wherein Z is a semiconductor.

7. A rechargeable battery as in claim 1, wherein Z is Al, Mg, Zn, or Si.

8. A rechargeable battery as in claim 1, wherein Z is Al.

9. A rechargeable battery as in claim 1, wherein Z is Mg.

10. A method of forming a rechargeable battery, comprising:
co-depositing Li and Z onto a substrate to form an anode comprising a Li-Z alloy, where Z is a metal or semiconductor and is present in an amount greater than 100 ppm but less than or equal to 10 wt % of the alloy, and wherein Z is substantially uniformly dispersed throughout a bulk portion of the anode;
providing a cathode comprising sulfur as an active cathode species; and
combining the anode and cathode into a layered structure to form a rechargeable battery.

11. A rechargeable battery having been discharged less than 10 times, comprising:
a cathode comprising sulfur as an active cathode species; and
an anode comprising a Li-Z metal alloy, where Z is a metal or semiconductor and is present in an amount greater than 100 ppm but less than or equal to 10 wt % of the alloy,
wherein Z is substantially uniformly dispersed throughout a bulk portion of the anode prior to 10^{th} discharge, and
wherein the rechargeable battery has a discharge capacity of at least 1800 mAh at the end of the 45^{th} cycle, the discharge capacity being at least 10% greater than that of a second rechargeable battery of essentially identical composition and dimension but comprising a Li anode without Z.

12. A rechargeable battery as in claim 11, wherein a potential difference between the anode of claim 11 and the anode of the second rechargeable battery is less than 5 mV.

13. A rechargeable battery as in claim 11, wherein a potential difference between the anode of claim 11 and the anode of the second rechargeable battery is less than 15 mV.

14. A rechargeable battery as in claim 11, wherein Z is a metal.

15. A rechargeable battery as in claim 11, wherein Z is a semiconductor.

16. A rechargeable battery as in claim 11, wherein Z is Al, Mg, Zn, or Si.

17. A rechargeable battery as in claim 11, wherein Z is Al.

18. A rechargeable battery as in claim 11, wherein Z is substantially uniformly dispersed throughout a bulk portion of the anode prior to 5^{th} discharge.

19. A rechargeable battery as in claim 11, wherein Z is substantially uniformly dispersed throughout a bulk portion of the anode prior to 3^{rd} discharge.

20. A rechargeable battery as in claim 11, wherein Z is substantially uniformly dispersed throughout a bulk portion of the anode prior to 1^{st} discharge.
